(19) United States
(12) Patent Application Publication
(10) Pub. No.: US 2009/0070138 A1
(43) Pub. Date: Mar. 12, 2009

(54) INTEGRATED CLINICAL RISK ASSESSMENT SYSTEM

(76) Inventors: Jason Langheier, Durham, NC (US); Quentin Spencer, Durham, NC (US); Ralph Snyderman, San Francisco, CA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/121,532

(22) Filed: May 15, 2008

Related U.S. Application Data
(60) Provisional application No. 60/938,101, filed on May 15, 2007.

(51) Int. Cl. G06Q 50/00

(52) U.S. Cl. 705/2

(57) ABSTRACT

A computer-implemented method is provided for analyzing patient risk and determining an individual therapeutic treatment plan for a cancer patient. The method includes entering patient medical information into a risk assessment tool; identifying any obtaining missing or out-of-date patient information; initializing the risk assessment tool based on the patient's demographics and cancer characteristics and determining a default treatment plan for the patient; modifying the default treatment plan by observing the modification of a risk score for the patient; and confirming a treatment order for the patient based on a balancing of the risk and treatment plan factors.

### CROSS-REFERENCE TO RELATED APPLICATIONS

This patent application claims the benefit of a provisional patent application entitled “Integrated Clinical Risk Assessment System,” filed on May 15, 2007 as U.S. patent application Ser. No. 60/938,101 by the inventors named in this patent application. The specification and drawings of the provisional patent application are specifically incorporated herein by reference. This application is also related to U.S. patent application Ser. No. 11/323,460 filed on Dec. 30, 2005 and claiming the benefit of provisional patent application Ser. No. 60/640,371 filed on Jul. 13, 2005.

### BACKGROUND OF THE INVENTION

The present invention relates generally to decision support systems for supporting therapeutic clinical decisions in a range of medical disciplines and, more particularly, to

Cancer chemotherapy is increasingly effective in prolonging remission or effecting cures in patients with cancer. Unfortunately, unanticipated severe myelosuppression can be an adverse consequence of chemotherapy. Knowledge of the likelihood of specific therapeutic adverse outcomes, such as severe and febrile neutropenia, anemia, and thrombocytopenia would go a long way toward increasing oncologists' effectiveness in making chemotherapy decisions to best meet the needs of individual patients.

Under-treatment as a consequence of concerns for myelosuppression may be an important factor leading to the lowered efficacy of chemotherapy and poorer survival rates of many patients, particularly older patients. A tool to predict an individual's specific risk of febrile and severe neutropenia, anemia, thrombocytopenia and other risks would allow oncologists to specifically intervene for those patients, without dose reducing chemotherapy or using expensive growth factors in patients not at risk. Chemotherapy agents, one of the most costly classes of drugs today, provide substantial hope for improved outcomes. Chemotherapy “cocktails” have continued to improve in their efficacy in treating many types of cancer and in their ability to increase survival time. Yet virtually all chemotherapy agents also carry significant, and often poorly understood, risks. Myelosuppression is the major toxic effect of chemotherapy that limits appropriate dosing due to its unpredictability. Based on randomized clinical trials published between 1990 and 2000, a meta-analysis reported hematologic toxicity in 66% of early stage breast cancer (ESBC) patients.

As an example, neutropenia, especially Febrile Neutropenia (FN, defined as absolute neutrophil count of less than 500 cells/uL with temperature elevation greater than 100° C.) is one major adverse side effect of chemotherapy, limiting treatment and causing catastrophic outcomes in many patients; it occurs in cycle 1 of chemotherapy in over 30% of ESBC patients.

Because many chemotherapies exhibit a steep dose/response curve, under-treatment constitutes an important, modifiable factor that lowers the efficacy of chemotherapy and decreases survival rates for cancer. Large clinical trials have shown decreased chemotherapy treatment efficacy resulting from under-treatment. Physicians typically under-treat due to fear of unpredictable adverse side effects. ESBC adjuvant chemotherapy at a dose level of less than 85% relative dose intensity (RDI) is associated with reduced survival. Yet a study of 20,000 ESBC patients found that 56% received less than 85% of the RDI, and 25% experienced treatment delays of 7 days or more.

Oncologists must routinely make risk-benefit decisions regarding chemotherapy in the course of clinical practice and they often do so without using well-founded guidelines, evidence-based rationale, or decision support protocols. The National Comprehensive Cancer Network and American Society for Clinical Oncology provide chemotherapy regimen guidelines based on expert panel reviews of the literature, but these guidelines are not refined to optimize decisions for individual patients, based on their specific risks and responses. Improvement in clinical care for cancer patients thus hinges on the development of strategies for improving oncology practitioners' clinical decisions, based on research evidence regarding risk factors and individual patient data that balances dose and risk considerations. With such information, physicians can determine the likelihood of their patient developing an adverse outcome with a recommended standard of care and thus modify therapy when needed. This will minimize needless undertreatment. It will also rationalize the use of expensive adjunctive therapies which may be effective in reducing risks.

Solid evidence-based methodologies, aligned with a specific patient's condition and work-up, make more informed decisions possible. The best individualized therapeutic decisions improve the likelihood of prolonging remission or effecting cures while decreasing the overall cost of cancer treatment and increasing the quality of life for the patient.

### SUMMARY OF THE INVENTION

Embodiments of the invention are directed to a decision support tool that integrates predictive modeling, model validation, model utilization, and decision support interface components to enable oncologists to provide their patients with more rational cancer chemotherapy for their specific needs. These decision support tools provide a strong foundation for evidence-based chemotherapy and help minimize adverse outcomes while maximizing the measurable delivery of standards of care chemotherapy.

In one aspect of the invention, a computer-implemented method is provided for analyzing patient risk and determining an individual therapeutic treatment plan for a cancer patient. The method includes entering patient medical information into a risk assessment tool; identifying any obtaining missing or out-of-date patient information; initializing the risk assessment tool based on the patient's demographics and cancer characteristics and determining a default treatment plan for the patient; modifying the default treatment plan by observing the modification of a risk score for the patient; and confirming a treatment order for the patient based on a balancing of the risk and treatment plan factors.

### BRIEF DESCRIPTION OF THE DRAWINGS

These and other advantages and aspects of the present invention will become apparent and more readily appreciated from the following detailed description of the invention taken in conjunction with the accompanying drawings, as follows.

FIG. 1 illustrates an overview of the risk assessment system components in accordance with an exemplary embodiment of the invention.

FIG. 2 illustrates the predictive modeler component in accordance with an exemplary embodiment of the invention.

FIG. 3 illustrates a clinical risk dashboard for detailed model information in accordance with an exemplary embodiment of the invention.

FIG. 4 illustrates a log-in screen for the chemotherapy solutions tool in an exemplary embodiment of the invention.

FIG. 5 illustrates a patient information interface for the chemotherapy solutions tool in an exemplary embodiment of the invention.

FIG. 6 illustrates a user interface display for ordering and performing tests for the chemotherapy solutions tool in an exemplary embodiment of the invention.

FIG. 7 illustrates an initial risk assessment and treatment plan dashboard for the chemotherapy solutions tool in an exemplary embodiment of the invention.

FIG. 8 illustrates a first user interface display for modifying treatment plan and risk for the chemotherapy solutions tool in an exemplary embodiment of the invention.

FIG. 9 illustrates a second user interface display for modifying treatment plan and risk for the chemotherapy solutions tool in an exemplary embodiment of the invention.

FIG. 10 illustrates a user interface display to confirm a treatment order for the chemotherapy solutions tool in an exemplary embodiment of the invention.

FIG. 11 illustrates an overview of the clinical solution delivery system in accordance with an exemplary embodiment of the invention.

FIGS. 12-15F represent a sample of the database schema for the invention. This schema describes how the data that supports operation of the system is organized and stored. Specifically:

FIG. 12 describes storage of drugs, routes, and treatment plans.

FIG. 13 describes storage of patient specific model input variables.

FIG. 14 describes storage of information essential to the operation of the system, such as system logs and practitioner accounts.

FIG. 15A-15C describe the data elements necessary to define models and their combination into bundles.

FIG. 15D-15F complete the data organization and storage requirements of the system by specifying appropriate data input, storage, and output elements.

FIG. 16 depicts an example of the Chemotherapy Solutions system deployed within the clinical workflow of a representative medical oncology clinic. In addition to the seamless fit within the clinical workflow, this diagram depicts the connections between Chemotherapy Solutions and systems common in medical oncology clinics.

### DETAILED DESCRIPTION OF THE INVENTION

The following description of the invention is provided as an enabling teaching of the invention and its best, currently known embodiments. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances, and are a part of the invention. Thus, the following description is provided as illustrative of the principles of the embodiments of the invention and not in limitation thereof, since the scope of the invention is defined by the claims.

Embodiments of the present invention are directed to flexible and accurate clinical decision support tools based on validated predictive models and innovative decision analysis frameworks. A practitioner-friendly web-based interface integrated with existing computerized patient data repositories guides the physician through logical steps in making evidence and standards of care-based chemotherapy decisions to maximize the therapeutic benefits and limit the risks and costs for patients with ESBC. Enhancements to the generalizable risk assessment system on which the decision support is built will allow it to be easily upgraded on an ongoing basis and used for additional cancer treatment and prevention tools in the future.

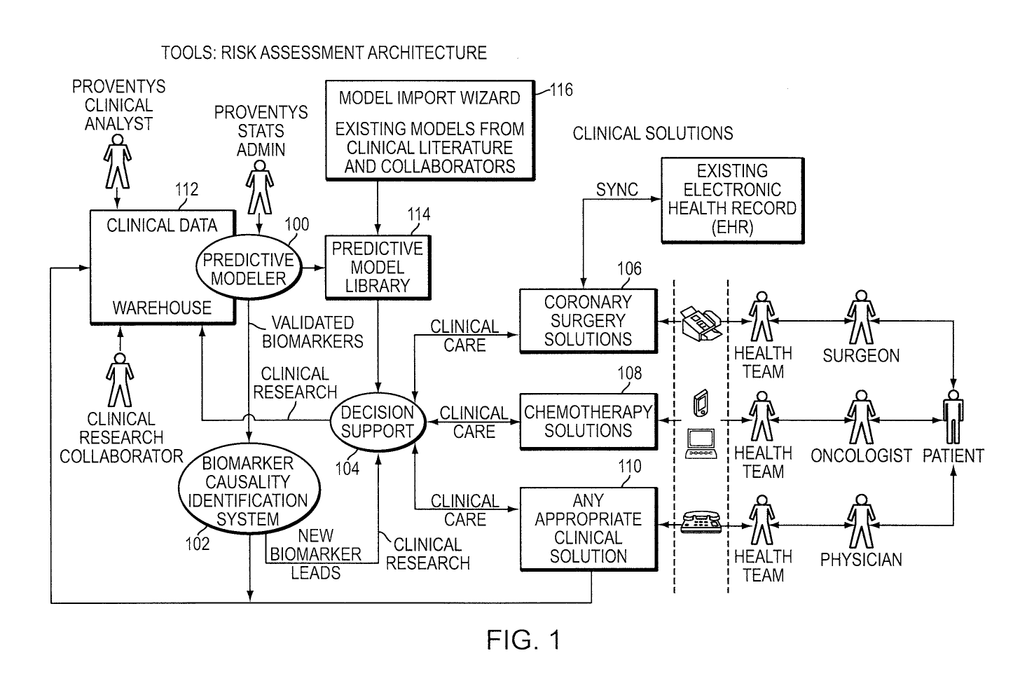

FIG. 1 illustrates an exemplary architecture of a system for developing and using predictive models according to embodiments of the invention. With reference to FIG. 1, the system includes a predictive modeler 100, a biomarker causality identification system 102, and one or more decision support modules 104-110. Predictive modeler 100 can generate predictive models based on clinical data stored in clinical data warehouse 112 and based on new factors identified by biomarker causality identification system 102. The models generated by predictive modeler 100 can be stored in predictive model library 114. Predictive model library 114 can also store models imported by a model import wizard 116. Model import wizard 116 can import existing models from clinical literature and collaborators.

Biomarker causality identification system 102 can automatically extract biomarkers from clinical literature and store that data in clinical data warehouse 112 for use by predictive modeler 100. Decision support modules 104-110 can apply the models generated by predictive modeler 100 to predict clinical or medical outcomes for individuals. In the illustrated embodiment, a coronary surgery solutions module 106 uses a model to predict outcomes relating to coronary surgery. A chemotherapy solutions module 108 predicts outcomes relating to chemotherapy. Decision support modules 104 and 110 are intended to be generic to indicate that the models generated by predictive modeler 100 can be applied to any appropriate clinical or medical solution. Modules 104-110 can be used by surgeons, physicians, and individuals to predict medical outcomes for a patient.

In one exemplary implementation, predictive modeler 100 can generate models from clinical and molecular data sequestered in data warehouse 112 regarding a population of individuals, thus linking predictive factors (predictors) in the population to clinical outcomes. In parallel, biomarker causality identification system 102 can validate additional biomarkers measured as part of the data collection process on new patients, that are true predictors even after considering confounding or collinearity with other factors. Newly validated biomarkers can then be used to generate better predictive models and decision support modules. Predictive model library 114 can store predictive models either generated by predictive modeler 100 or imported via model import wizard 116 for manual entry of models from the literature or exported from other applications in Predictive Model Markup Language (PMML). Sets of models can be bundled to address a key clinical decision that depends on multiple outcomes and requires stages of testing and screening for optimal cost-effectiveness.

Decision support module, such as one of modules 104-110, as part of a given clinical solution, receives input from an individual and diagnostic team regarding factors possessed by the individual and input regarding potential interventions and applies at least one of the models in predictive model library 114 to the input. The decision support module outputs results indicating the individual's risk of having one of the clinical outcomes, given that individual's factors and the selected intervention strategy. The decision support module automatically constructs a probability and cost-effectiveness decision tree that allows the practitioner to rapidly select either the most beneficial or most cost-effective intervention strategy possible.

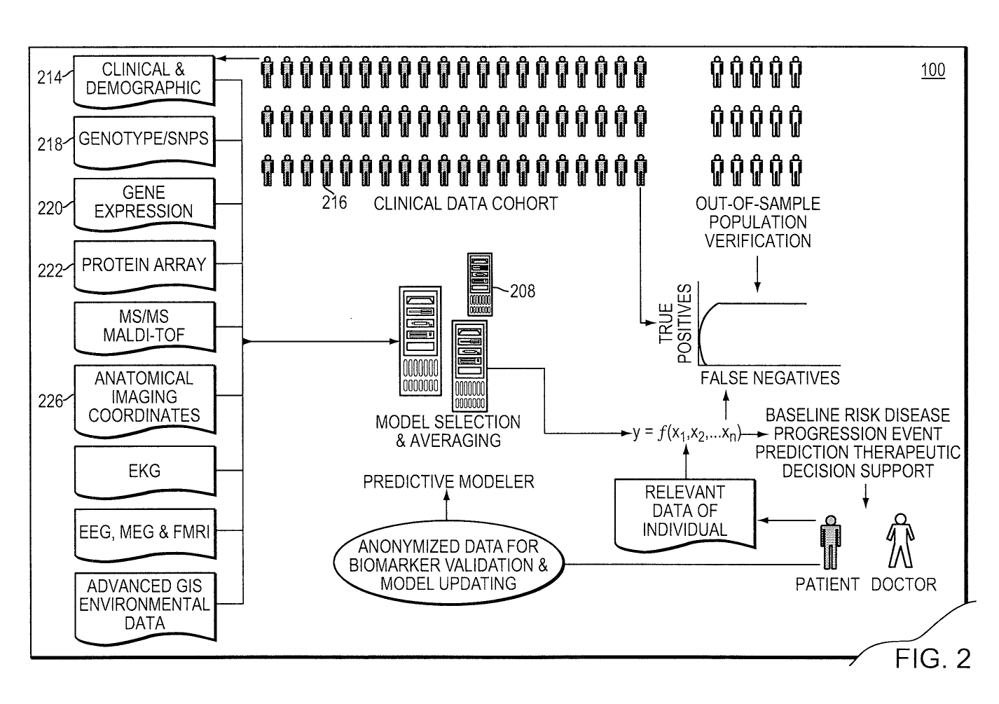

FIG. 2 illustrates exemplary components and data used by predictive modeler 100. A model selection and averaging module 208 selects a model from a plurality of models based on practitioner-defined factors, such as predictive value and cost. The result of model selection and averaging is one or more models that can be used to predict a medical outcome for a patient.

Predictive model 100 receives clinical data from a plurality of different sources. In the illustrated example, these sources include clinical data 214 from a clinical data cohort 216, genotype and single nucleotide polymorphisms (SNPs) 218, gene expression data 220, proteomic data 222, metabolic data 224, and imaging or electrophysiology data coordinates 226. These coordinates can come from various sources such as x-ray mammography, computerized axial tomography, magnetic resonance imagining, electrocardiograms, electroencephalography, magnetoencephalography, and functional magnetic resonance imaging sources.

A more comprehensive description of the techniques for generating and applying predictive models to medical outcomes is provided in U.S. patent application Ser. No. 11/323,460, incorporated by reference in its entirety herein.

The chemotherapy solutions module 108 (FIG. 1), is an online risk assessment and therapeutic decision support tool that integrates seamlessly into the physician's workflow. It helps the physician make critical therapeutic decisions to optimize the choice of chemotherapeutics, supportive therapies, growth factors and the relative dose intensity (as compared with a standard or recommended dose) of chemotherapy in order to maximize overall survival time and remission likelihood, while minimizing the likelihood of severe or febrile neutropenia and other adverse outcomes. Comprehensive analysis of relevant clinical databases were used to identify specific risk factors which were then integrated into a number of versions of accurate predictive models. The risk models have been incorporated into the chemotherapy solutions tool described herein that allows the clinician to maximize the benefit of cancer chemotherapy and rationalize the use of expensive growth factors while minimizing the risk of adverse outcomes for the specific patient being treated. Any enhanced predictive model of an adverse outcome such as one predicting febrile neutropenia, can be incorporated into the system by hand, or by import of a Predictive Model Markup Language file. In many cases, the predictive models take the form of a logistic regression or a classification and regression tree (CART) model.

The chemotherapy solutions tool provides the oncologist with an instantaneous analysis of the patient's risk of severe or febrile neutropenia associated with the oncologist's choice of chemotherapy. The impact of varying the chemotherapy regimen selection, cycle length, or addition of growth factors is instantaneously displayed. If desired, the physician can use the tool for direct order entry of therapeutics. This groundbreaking evidence-based approach is now enabling personalized, predictive cancer care.

As illustrated in FIG. 2, the chemotherapy solutions online risk assessment and therapeutic support tool incorporates powerful biostatistical modeling and clinical data mining technologies which have identified complex patterns of biomarkers and clinical data that are highly correlated with specific outcomes in individual patients. These modeling techniques, complemented by a customized risk scoring and decision analysis engine, have been incorporated into a tool to enable dynamic and iterative evidence-based risk assessment to aid the clinician in identifying the most satisfactory treatment plan for each patient.

The technology platform underlying the chemotherapy solutions tool is capable of supporting a wide range of clinical solutions in a range of medical disciplines. Biostatistical models can be created for outcome prediction for any specific clinical event for which sufficient data has been gathered in an appropriate manner. For the chemotherapy solutions tool, the Awareness of Neutropenia in Chemotherapy (ANC) prospective study database of 131 randomly selected oncology practices was used. The ANC Study Group, directed from the Wilmot Cancer Center at the University of Rochester Medical Center, was formed in September 2000 to develop more accurate prediction models for neutropenia and other adverse events due to chemotherapy. Logistic regression models to predict febrile and severe neutropenia have been created from this data; these models or any future models can be incorporated into the chemotherapy solutions tool for use with cancer chemotherapy decision support.

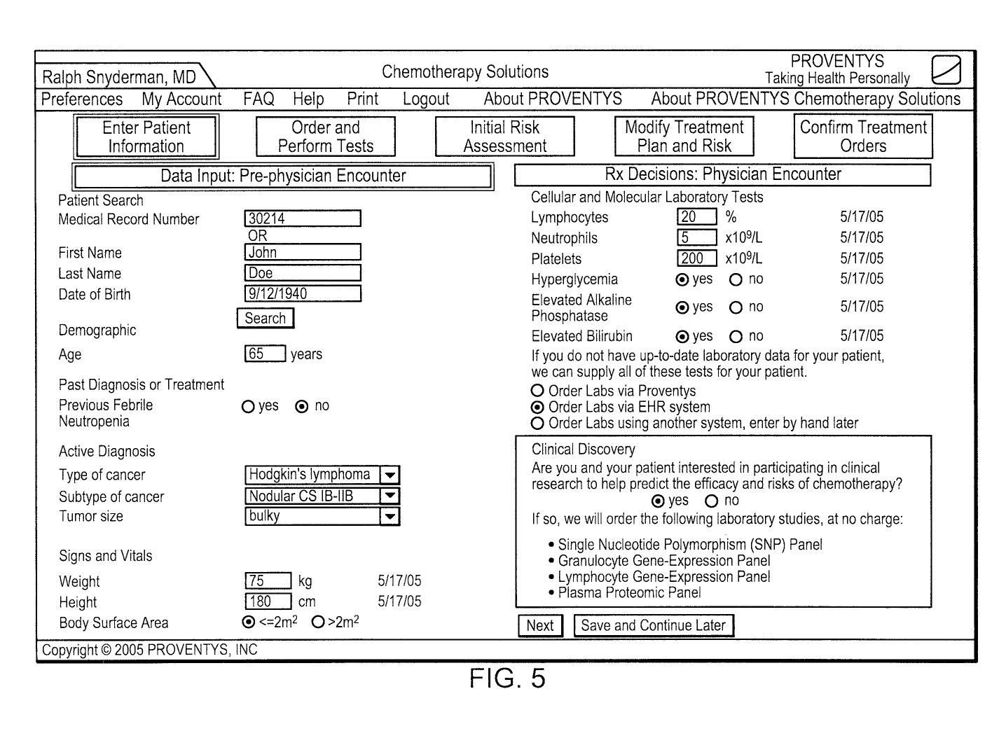

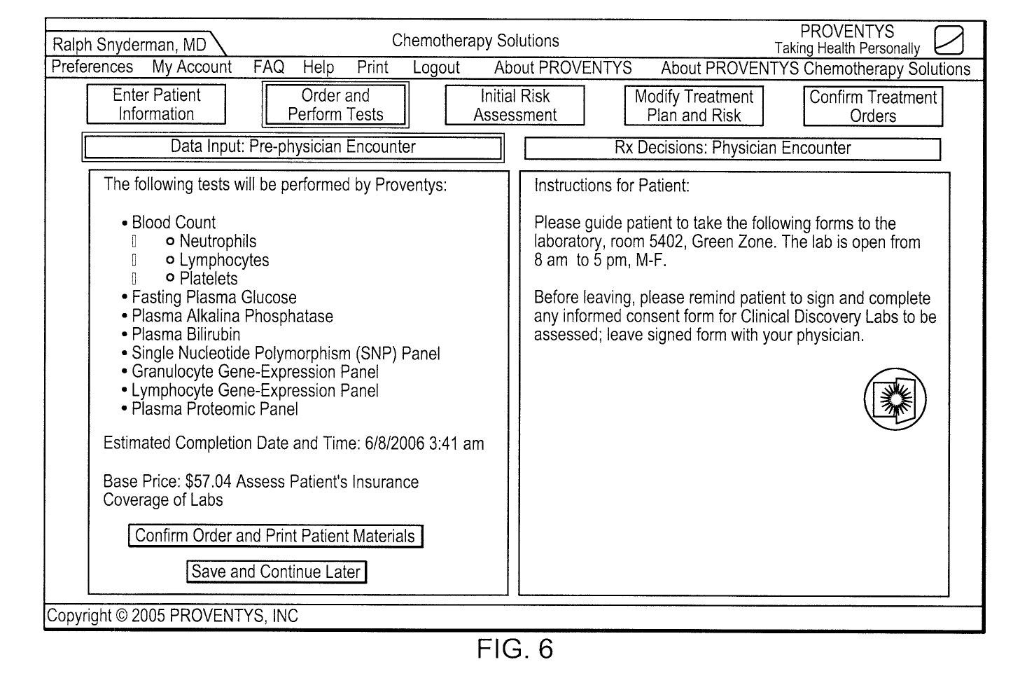

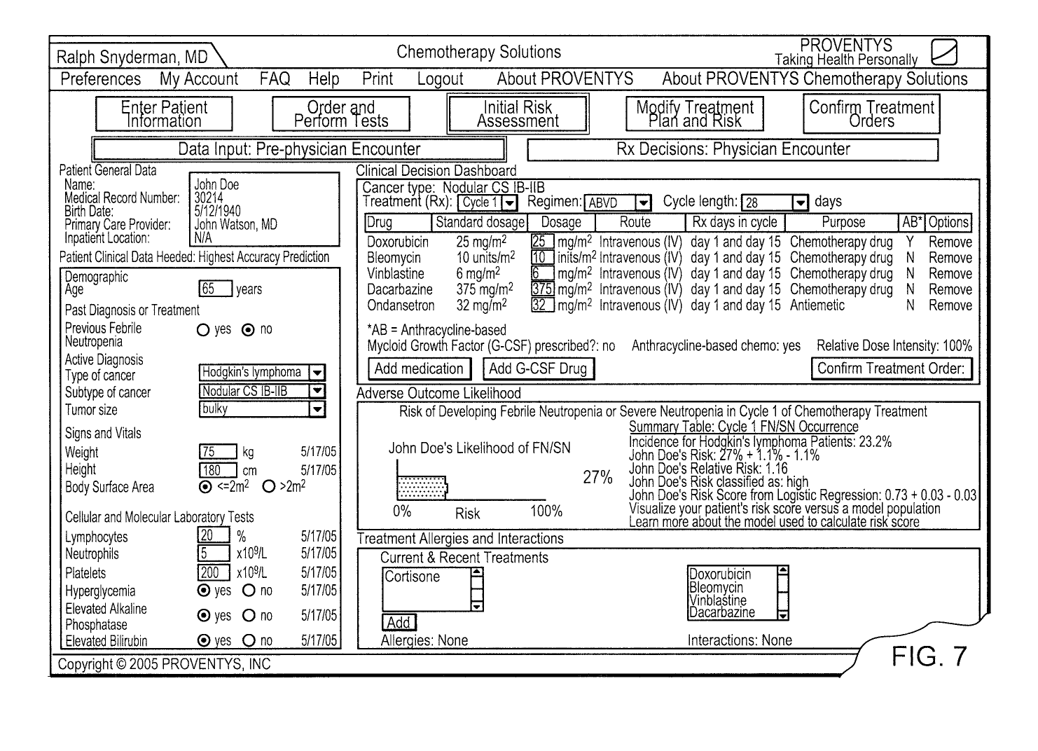

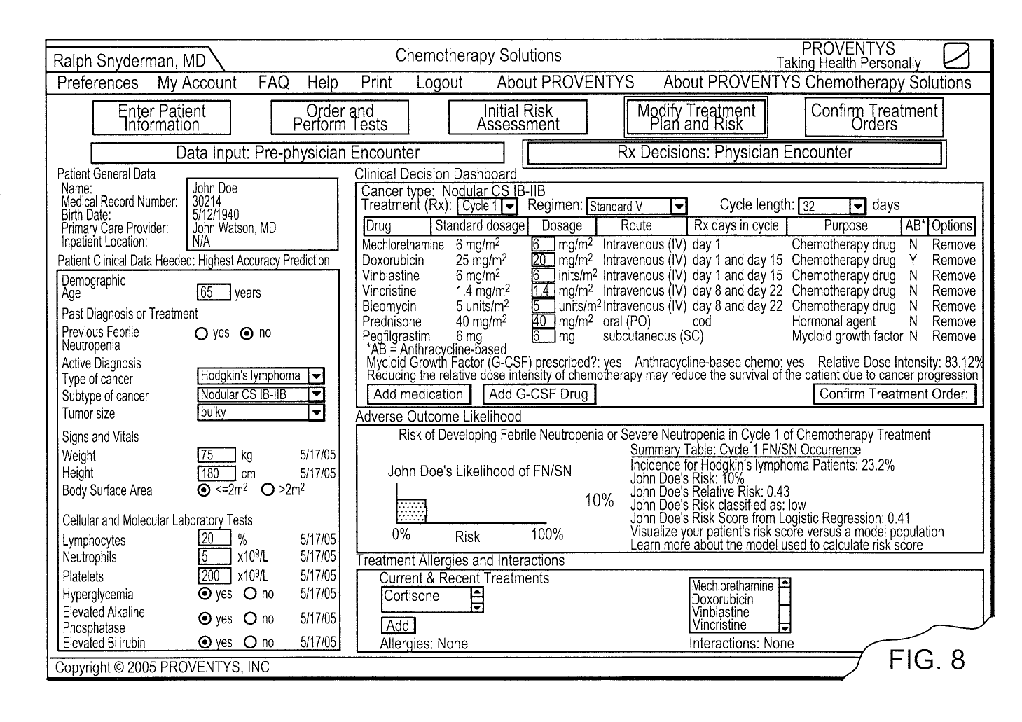

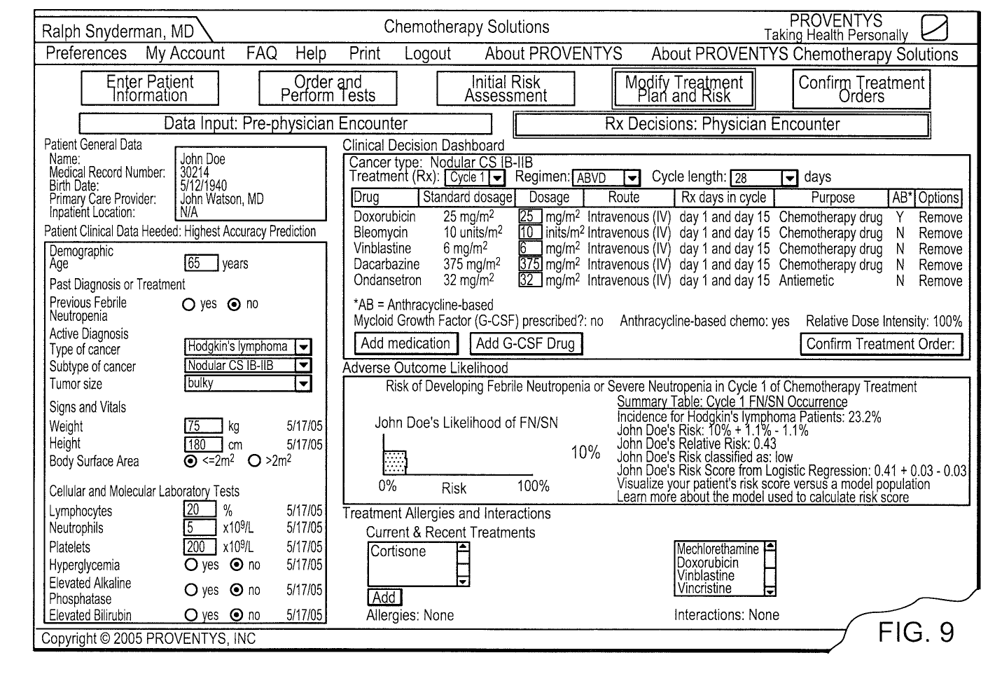

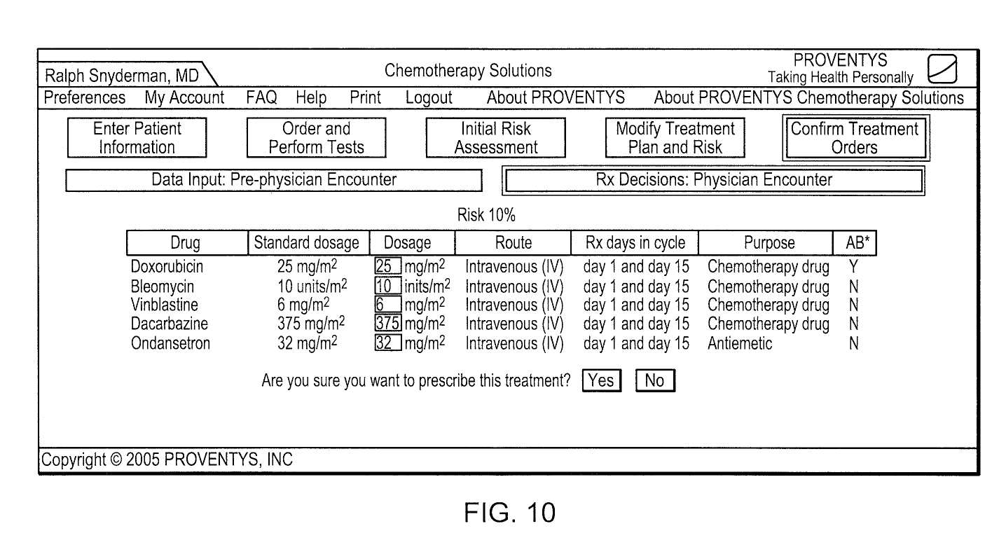

The chemotherapy solutions tool uses a proprietary clinical decision engine accessed through standard web-based Internet service that is as easy to use as any web service. The solution is designed to integrate smoothly into the workflow found in oncology practices, moving through the following steps:
1. Identify the patient and enter relevant patient data. FIG. 5 illustrates a patient information practitioner interface for the chemotherapy solutions tool in an exemplary embodiment.
2. Assure that the patient's medical information is current and complete. The system identifies any missing or out-of-date patient information or lab results and summarizes needed orders for simple one-click ordering. FIG. 6 illustrates a practitioner interface display for ordering and performing tests for the chemotherapy solutions tool in an exemplary embodiment.
3. Upon availability of current patient information, the chemotherapy solutions model and practice-specific default treatment plans are initialized based on the patient's demographic and cancer characteristics. Such default treatment plans can be based on national expert recommendations such as those from the National Comprehensive Cancer Network, or local standards for appropriate use of cancer chemotherapies. The patient's specific severe or febrile neutropenia risk data is analyzed by scoring the predictive models derived from the ANC database with the relevant patient and procedure characteristics; this involves automatic calculation of a probability and likelihood ratio by insertion of relevant patient and procedure values (0 or 1 for dichotomous variables such as use of growth factor versus no use of growth factor, continuous number for elements such as age) into the predictive model equations. An example of a febrile neutropenia model derived from the ANC database is shown in Table 1A described below. An example of an anemia model that can also be used within Chemotherapy Solutions is shown in Table 1B described below. The predictive accuracy of these particular models are shown in Table 2 below. The system is not limited to using models created from the ANC database. The result of scoring is instantly presented to the nurse or physician in numeric form and as a bar graph color coded to practice-specific risk threshold settings. FIG. 7 illustrates an initial risk assessment and treatment plan dashboard for the chemotherapy solutions tool that includes an adverse outcome likelihood bar graph in an exemplary embodiment.
4. The physician can modify the recommended treatment plan observing the modification of the risk score in real time. FIGS. 8-9 illustrate iterative practitioner interface display for modifying treatment plan and risk in an exemplary embodiment. This iterative mode enables rapid scenario analyses and can be enhanced with practice-specific compliance alerts.
5. Upon reaching a satisfactory balance of risk and treatment plan factors, the physician confirms the therapeutic orders for delivery to pharmacy and patient infusion processes. FIG. 10 illustrates a practitioner interface display to confirm a treatment order for the chemotherapy solutions tool in an exemplary embodiment.

As the patient moves to a second course of chemotherapy, the service can be run again with updated patient data. Patient results are maintained in accordance with HIPAA compliance and are used to track patient progress. Additionally, patient results can be used, with patient consent, for further refinement of the statistical model.

The various embodiments of the invention can include the following features: (1) prospective medicine puts into practice risk assessment scores of febrile and severe neutropenia based on large volumes of clinical data analyzed with biostatistical models to predict outcomes based on therapeutic choices; (2) iterative risk scoring to enable scenario analyses in support of therapeutic decisions; (3) therapeutic regimens and thresholds customized to individual or institutional preferences; and (4) integration with existing patient information and order entry systems.

The various embodiments of the invention can also include the following features: (1) streamlined integration with existing enterprise portal or systems enabling: (a) integrated enterprise log-in, (b) automatic population of pertinent patient data from electronic medical records (EMR), and (c) automatic delivery of lab and pharmacy orders to CPOE or lab and pharmacy systems; (2) quality assurance/quality control (QA/QC) reporting interface; and (3) therapeutic validation and/or billing interface to payer.

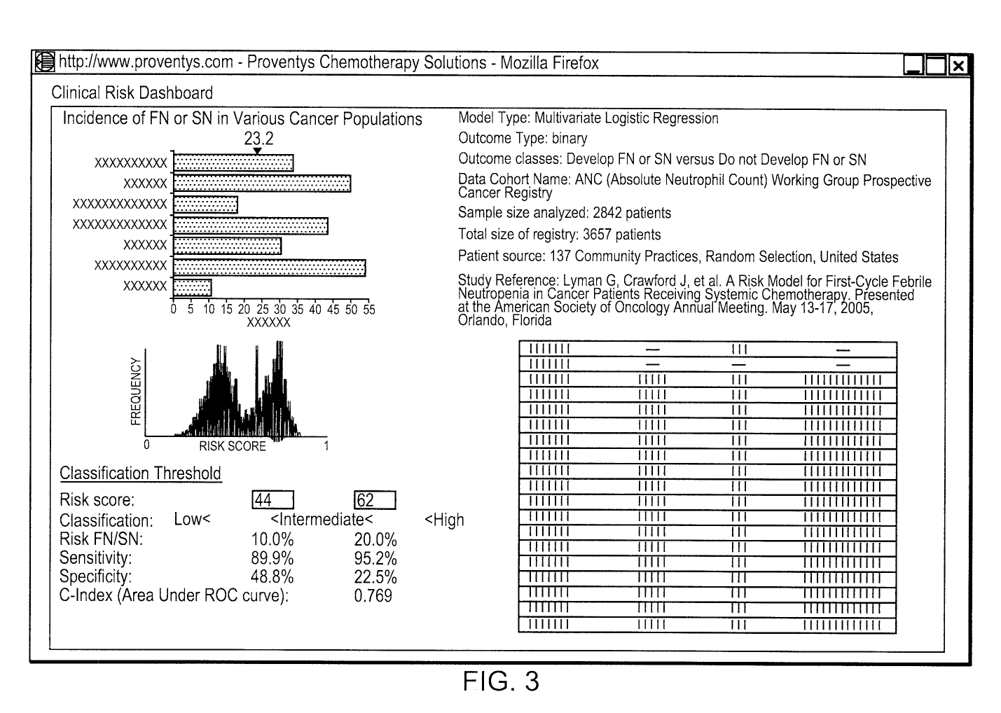

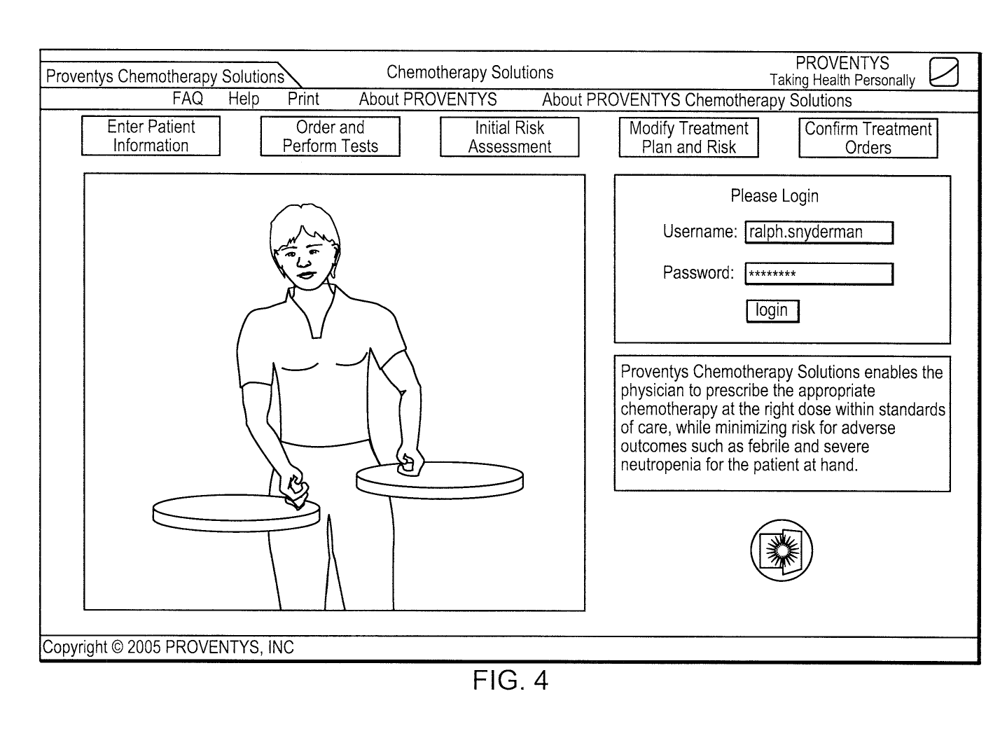

FIGS. 3-10 illustrate exemplary practitioner interfaces and functionality that can be provided for the chemotherapy solutions tool in exemplary embodiments. FIG. 4 illustrates an exemplary login screen for the chemotherapy solutions tool. The purpose of the chemotherapy solutions tool is to evaluate and present outcomes associated with particular chemotherapy regimens. FIG. 5 illustrates a patient information practitioner interface for the chemotherapy solutions tool in an exemplary embodiment. Age, demographic information, and lab test information is obtained for an individual. The individual is also prompted as to whether the individual is willing to participate in clinical research to assist in new biomarker validation. If the individual indicates such willingness, the individual then will be presented with the appropriate consent forms for participating in biomarker validation and the appropriate orders will be sent to the lab that will conduct the tests required for biomarker validation.

The chemotherapy solutions tool can present the practitioner with an order and perform tests interface display, as illustrated in FIG. 6. The order and confirm test screen includes the lab tests ordered and instructions for the patient. When the practitioner clicks “Confirm Order and Print Patient Materials,” the chemotherapy solutions tool automatically orders the selected tests from a lab.

The next practitioner interface screen presented by chemotherapy solutions tool is the initial risk assessment screen, as illustrated in FIG. 7. The initial risk assessment screen displays lab data for the individual. In addition, the risk assessment screen includes a clinical decisions dashboard that indicates the individual's risk of developing febrile neutropenia as a result of a chemotherapy regimen. The dashboard displays the drugs involved in the chemotherapy regimen and the dosage amounts of each drug. The drugs and dosage amounts are modifiable by the practitioner. If the practitioner modifies the drugs or the dosage amounts, chemotherapy solutions module 108 will automatically recalculate the individual's risk of developing febrile neutropenia. In addition, the dashboard allows the practitioner to modify treatment orders or add a G-CSF drug. In response to either of these actions, chemotherapy solutions module 108 will recalculate the individual's risk of febrile neutropenia. Thus, the dashboard illustrated in FIG. 7 provides a convenient method for a physician or a patient to evaluate different outcomes and treatment options.

FIG. 8 illustrates an exemplary modify treatment plan screen that can be displayed by the chemotherapy solutions tool if the practitioner modifies any of the medications illustrated in FIG. 7. In FIG. 8, it can be seen that the individual's risk of febrile neutropenia has decreased from 27% to 10% as a result in changes of dosage amounts of some of the drugs displayed by the dashboard.

FIG. 9 illustrates another example of a modify treatment plan and risk screen for a different individual that can be displayed by the chemotherapy solutions tool. In the illustrated example, the individual has a low risk of febrile or sever neutropenia for the given chemotherapy regimen. Thus, even though adding a G-CSF drug would reduce the individual's risk of febrile or severe neutropenia, the cost of adding the G-CSF drug is not work the benefit, given that such drugs are expensive.

From either the initial risk assessment display or the modify treatment plan display, the practitioner can select, “visualize your patient's risk score versus model population, learn more about model used to generate risk score” and the chemotherapy solutions tool will display the individual's risk versus the model population and model details. FIG. 3 illustrates an example of such a comparison screen that can be displayed by the chemotherapy solutions tool. The individual's risk of developing febrile or severe neutropenia versus the population is presented in graphical and text format. In addition, the source of the model used to generate the risk score is displayed.

Once the practitioner selects the “Confirm Treatment Orders” button from the initial risk assessment display or the modify treatment plan display, the chemotherapy solutions tool displays a confirm treatment orders screen, as illustrated in FIG. 10. The drugs and dosage amounts selected by the physician are displayed. The risk of febrile or sever neutropenia associated with the selected regimen is also displayed.

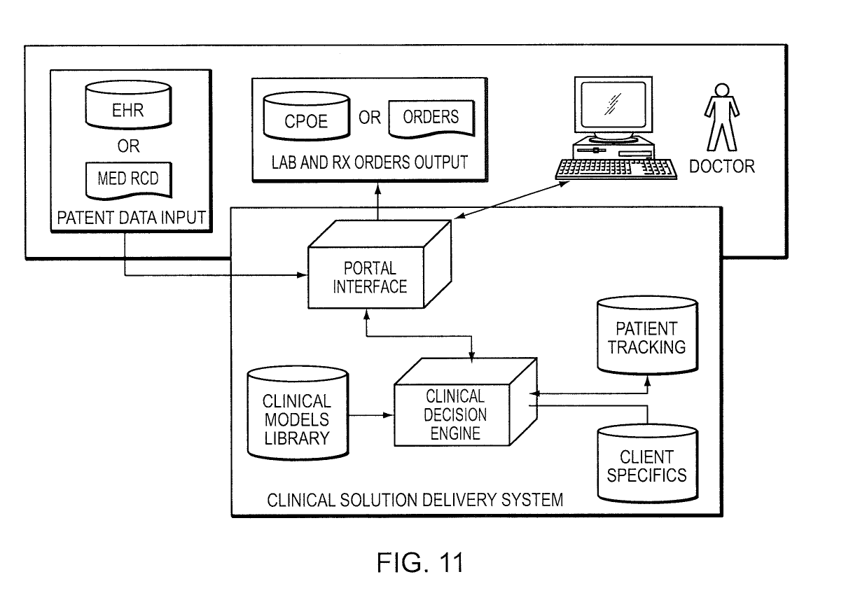

FIG. 11 depicts the fit of the chemotherapy solutions tool within the clinical workflow. Inputs come from an electronic medical record system (EMR) or manual entry from patients charts, and outputs go to a physician order entry system.

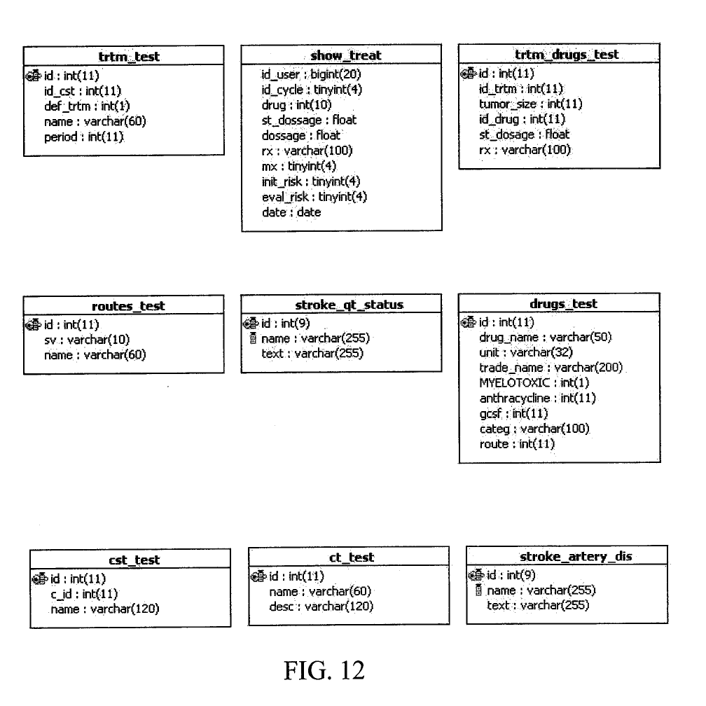

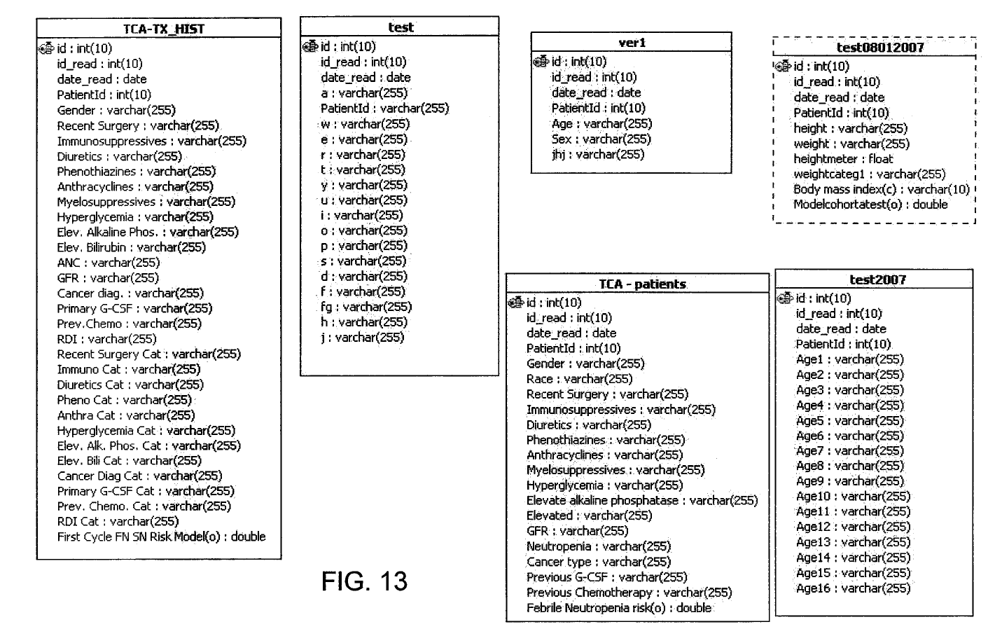

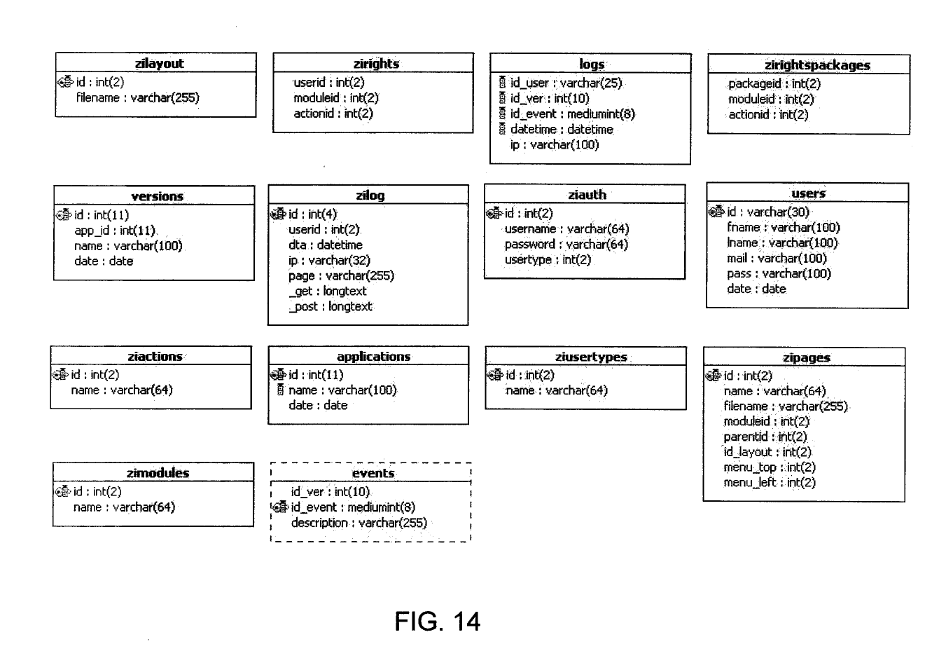

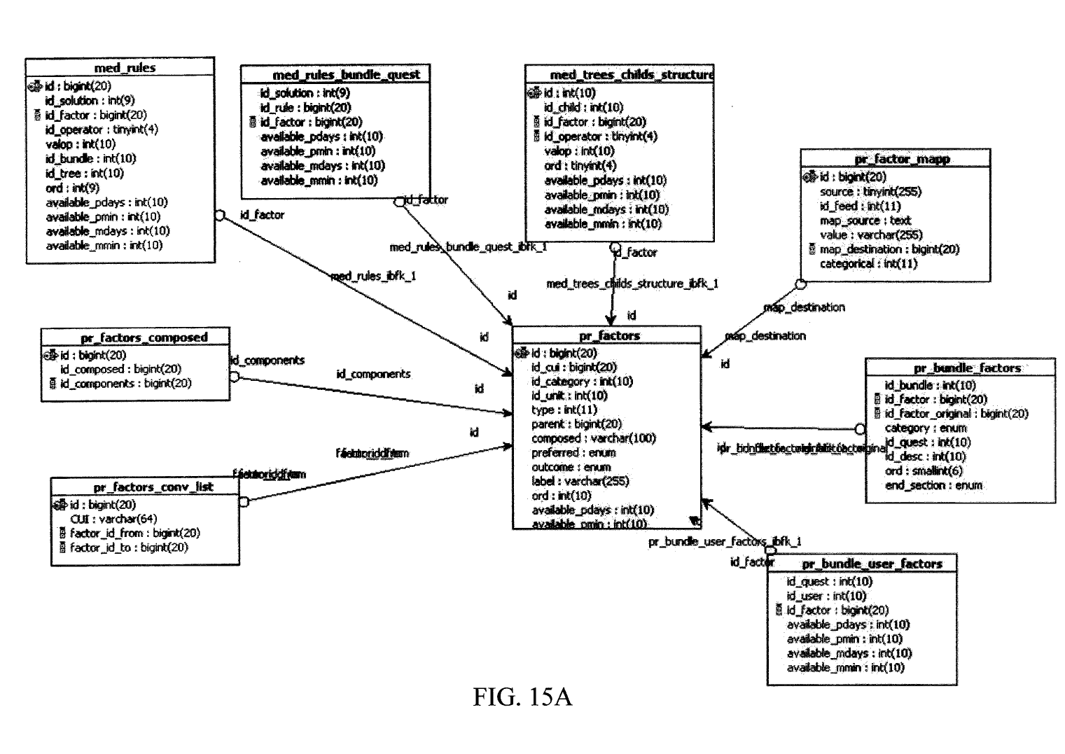

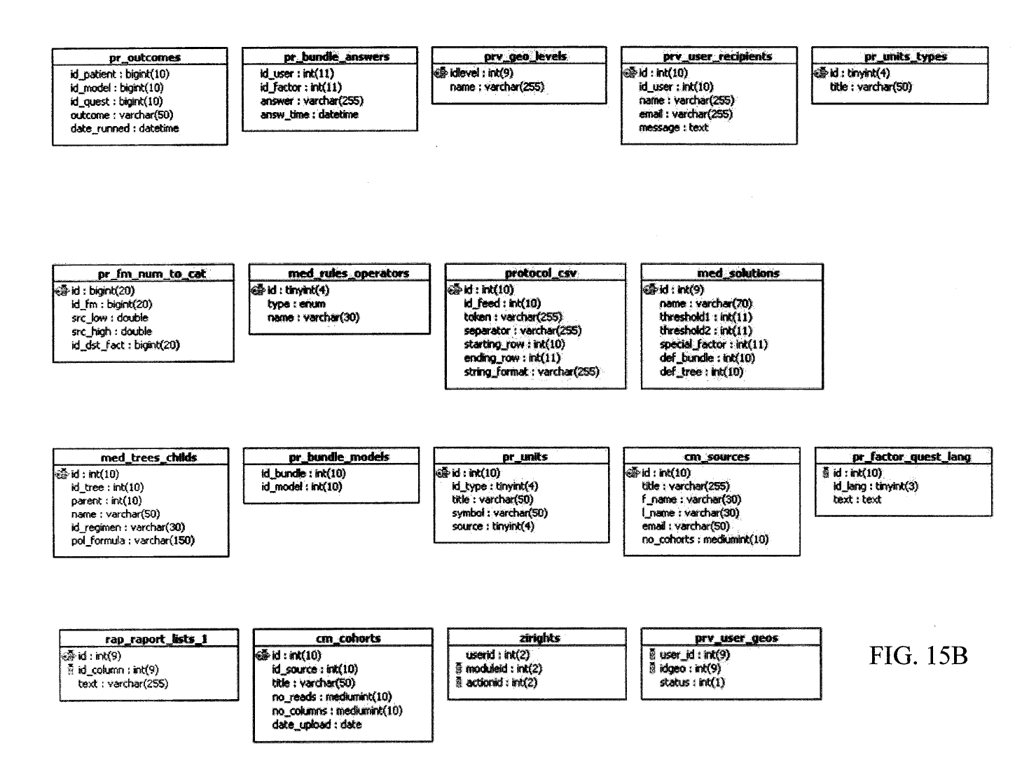

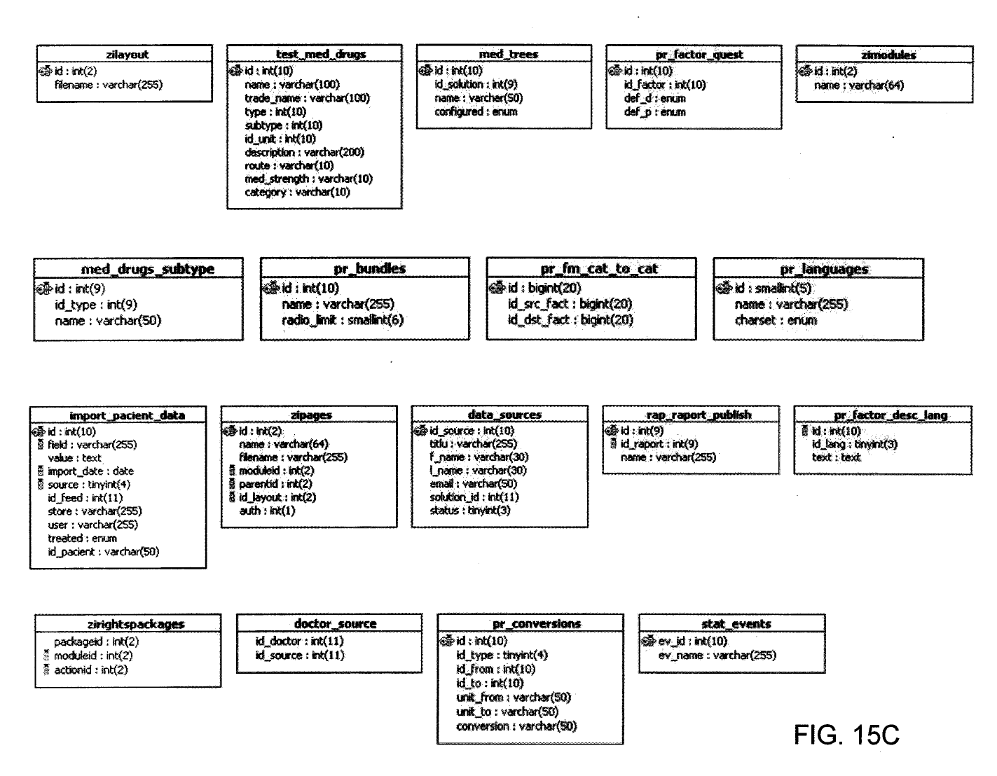

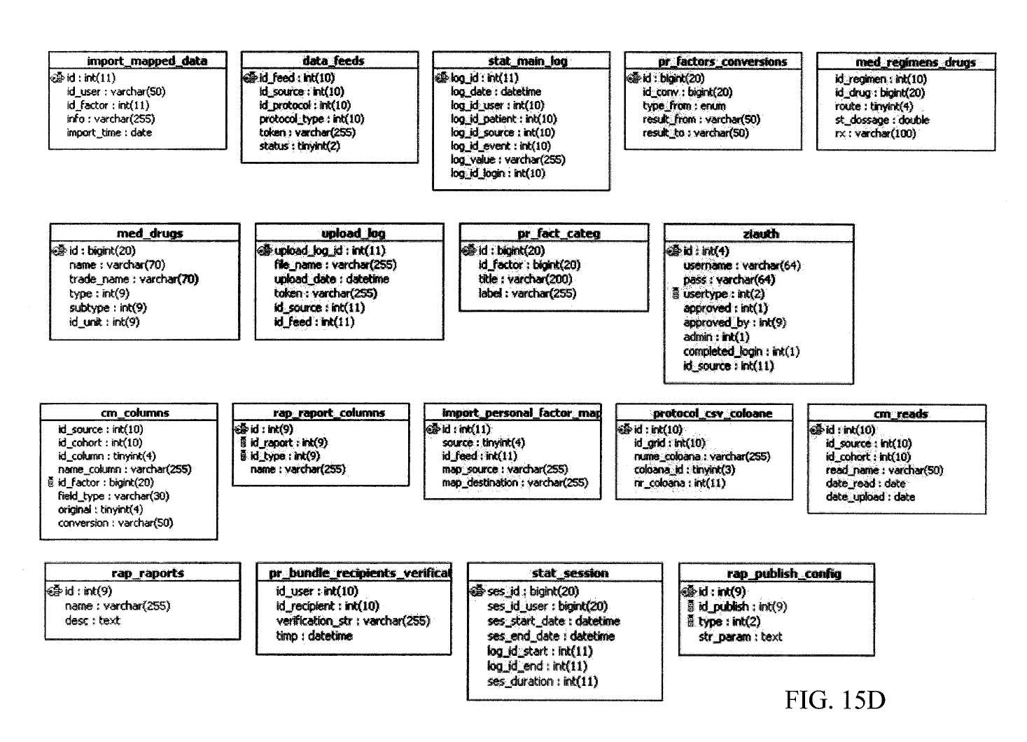

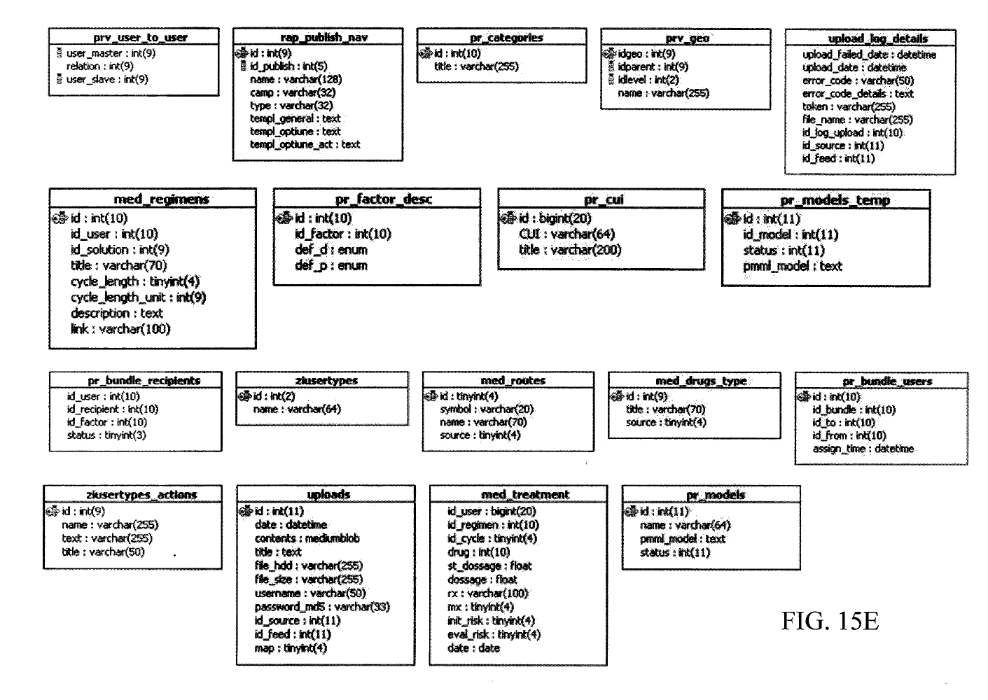

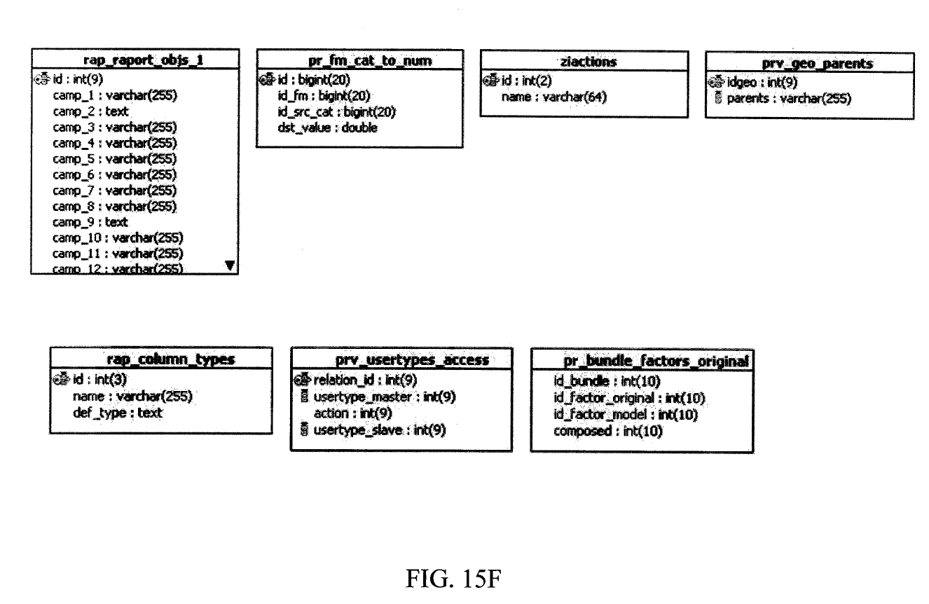

FIGS. 12-15F represent a sample of the database schema for the invention. This schema describes how the data that supports operation of the system is organized and stored. FIG. 12 describes storage of drugs, routes, and treatment plans. FIG. 13 describes storage of patient specific model input variables. FIG. 14 describes storage of information essential to the operation of the system, such as system logs and practitioner accounts. FIGS. 15A-15C describe the data elements necessary to define models and their combination into bundles. FIGS. 15D-15F complete the data organization and storage requirements of the system by specifying appropriate data input, storage, and output elements.

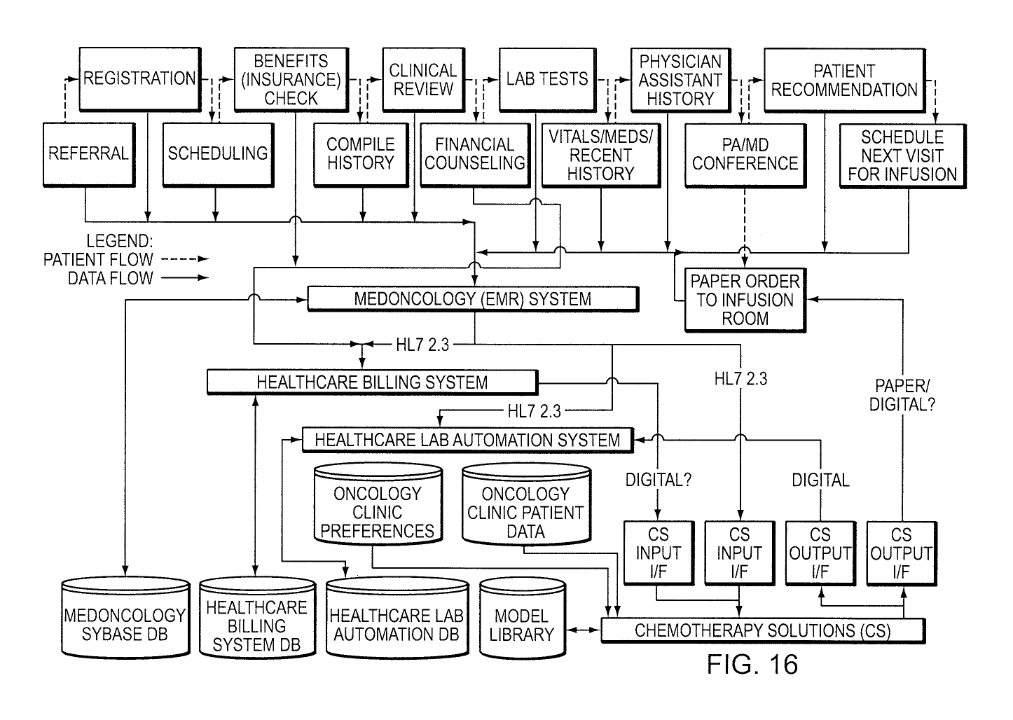

FIG. 16 depicts an example of the chemotherapy solutions system deployed within the clinical workflow of a representative medical oncology clinic. In addition to the seamless fit within the clinical workflow, this diagram depicts the connections between Chemotherapy Solutions and systems common in medical oncology clinics.

With further reference to FIG. 1, the risk assessment system of the invention includes standardized data library, predictive modeler, biomarker validation, model library and decision support interface components. Further, the Awareness of Neutropenia in Chemotherapy (ANC) prospective cohort study of 117 randomly selected community oncology practices has generated data on more than 4500 patients and validated predictive models for the risk of febrile neutropenia and anemia, with additional models being validated and built for thrombocytopenia and other risks of chemotherapy. FIG. 11 illustrates an overview of the clinical solution delivery system.

The decision support (DS) interface component is an interactive practitioner interface creator, and a template that can collect information from physicians, patients, testing centers, and legacy data sources in order to calculate risk using a proprietary PHP-based scoring tool for Predictive Model Markup Language (PMML) reference predictive models stored in the model library. The DS interface then displays the probability and timing of an adverse event in an at-risk patient and the prediction interval around these risk scores. The DS component stores multiple predictive models derived from a variety of sources and in diverse formats, some based on algorithms and data tables published in the medical literature and incorporated using its model import wizard, others derived from the predictive modeling suite that includes standard and custom statistical functions, many of which are based on R tools.

Detailed information on adverse outcome incidence and models and data used to calculate individual risks are shown in additional information windows accessible to practitioners as illustrated in the clinical risk dashboard illustrated in FIG. 3. With the goal of increasing use of evidence-based models, the DS interactively engages physicians and their patients, clearly states questions and recommendations, simplifies collection of patient data, and provides prognostic reports in practitioner-friendly format. The view of risks is standardized input data and for any adverse outcome risk reporting, but differs if there is one versus many risks. FIG. 7 illustrates an exemplary risk assessment and treatment plan dashboard.

The risk assessment system has imported models designed and validated by investigations into the model library. These logistic regression models were created and validated to predict the risk of febrile or severe neutropenia (FN/SN) (Table 1A) and anemia (Table 1B) as a result of chemotherapy for a number of cancers, including breast cancer, lymphomas, lung cancers, and ovarian cancer. Models for these problems help to guide chemotherapy regimen and dosage selection, and the use of costly growth factors such G-CSF and erythropoietin. Models specifically constructed for ESBC cycle 1 FN/SN have been validated and presented at the American Society for Clinical Oncology (ASCO) conference in June 2006.

All of these predictive models have been generated from the Awareness of Neutropenia in Chemotherapy (ANC) prospective study of over 4500 patients from 117 medical oncology practices randomly selected from across the U.S. Investigators split the data into a training set and a testing set, and assessed the predictive accuracy of the models. Table 2 shows the predictive accuracy of adverse outcomes models of chemotherapy for febrile/severe neutropenia and anemia.

TABLE 1A
Logistic Regression for FN/SN

| Variable | B (SE) | | P | Odds ratio (95% CI) |
|---|---|---|---|---|
| Cancer type | — | | — | — |
| Small cell lung cancer | 2.063 | (0.308) | .000 | 7.873 (4.307-14.391) |
| Ovarian Cancer | 0.0812 | (0.337) | 0.016 | 2.253 (1.163-4.364) |
| Non-Hodgkin's | 0.076 | (0.341) | 0.823 | 1.079 (0.553-2.105) |
| lymphoma | | | | |
| Non-small cell lung | 0.238 | (0.309) | 0.441 | 1.269 (0.692-2.326) |
| cancer | | | | |
| Breast Cancer | 0.674 | (0.306) | 0.027 | 1.962 (1.078-3.571) |
| Hodgkin's lymphoma | 0.155 | (0.459) | 0.735 | 1.168 (0.475-2.872) |
| Age | 0.014 | (0.005) | 0.006 | 1.014 (1.004-1.024) |
| Hyperglycemia | 0.302 | (0.117) | 0.010 | 1.353 (1.076-1.703) |
| Elevated alkaline | 0.404 | (0.165) | 0.014 | 1.497 (1.083-2.069) |
| phosphatase | | | | |
| Elevated billirubin | 0.734 | (0.287) | 0.011 | 2.082 (1.186-3.658) |
| Platelets (×10%/L) | −0.001 | (0.001) | 0.018 | 0.999 (0.997-1.000) |
| Neutrophils (×10%/L) | −0.058 | (0.025) | 0.021 | 0.943 (0.898-0.991) |
| Lymphocytes (%) | −0.017 | (0.007) | 0.012 | 0.983 (0.969-0.996) |
| Anthracycline-based | 1.964 | (0.197) | .000 | 7.126 (4.847-10.477) |
| BSA ≦ 2 m2 | 0.361 | (0.159) | 0.023 | 1.434 (1.051-1.957) |
| Planned RDI >85% | 0.482 | (0.155) | 0.002 | 1.620 (1.196-2.195) |
| Primary prophylaxis | −0.852 | (0.360) | 0.018 | 0.426 (0.211-0.863) |
| Constant | −3.483 | (0.531) | .000 | 0.031 |

TABLE 1B
Logistic Regression for Anemia

| Variable | B (SE) | P | Odds ratio (95% CI) |
|---|---|---|---|
| History of | 0.803 (0.309) | 0.009 | 2.233 (1.219-4.091) |
| CHF | | | |
| History of | 0.593 (0.269) | 0.028 | 1.809 (1.067-3.065) |
| ulcer | | | |
| ECOG > 1 | 0.393 (0.177) | 0.015 | 1.482 (1.047-2.096) |
| Age | 0.018 (0.004) | .000 | 1.018 (1.010-1.027) |
| Charlson | 0.038 (0.019) | 0.044 | 1.038 (1.001-1.077) |
| Comorbid Ind | | | |
| Anthracycline | 0.856 (0.160) | .000 | 2.353 (1.719-3.222) |
| Carboplatinum | 0.606 (0.186) | 0.001 | 1.833 (1.273-2.638) |
| Cisplatinum | 0.601 (0.289) | 0.038 | 1.823 (1.034-3.214) |
| BSA | 0.653 (0.206) | 0.001 | 1.922 (1.284-2.875) |
| Low Hgb | 0.457 (0.116) | .000 | 1.580 (1.259-1.981) |
| Female | 0.761 (0.148) | .000 | 2.140 (1.600-2.862) |
| Creatinine | 0.584 (0.166) | .000 | 1.793 (1.297-2.481) |
| Baseline Hgb | −0.574 (0.038) | .000 | 0.563 (0.522-0.607) |
| Cancer type | — | — | — |
| Small cell | 1.768 (0.302) | .000 | 5.858 (3.240-10.590) |
| lung cancer | | | |
| Ovarian cancer | 0.337 (0.272) | 0.215 | 1.400 (0.822-2.384) |
| Lymphoma | 0.340 (0.253) | 0.178 | 1.406 (0.857-2.306) |
| Non-small | 0.656 (0.242) | 0.007 | 1.927 (1.200-3.094) |
| cell lung | | | |
| cancer | | | |
| Breast cancer | 0.367 (0.229) | 0.109 | 1.443 (0.921-2.261) |
| Plan cycle | 0.850 (0.158) | .000 | 2.339 (1.715-3.191) |
| length > 14 d | | | |
| Planned RDI > 85% | 0.346 (0.129) | 0.008 | 1.413 (1.097-1.821) |

These predictive models have been imported into the model library employing the model import wizard in order to (1) use these predictive models in the decision support system, and (2) further assess their predictive power in out-of-sample validations.

TABLE 2
Predictive Accuracy of Adverse Outcomes Models of Chemotherapy

| | Febrile/Severe | |
|---|---|---|
| | Neutropenia | Anemia |
| Cycles of chemotherapy | 1 | 1 through 4 |
| c-statistic (Area under | 0.77 (95% CI, 0.75-0.79) | 0.80 (95% CI, 0.78-0.82) |
| ROC curve) | | |
| Example threshold | 10% risk | 21.8% risk (median) |
| chosen | | |
| Sensitivity at threshold | 89.9% (95% CI, 85.8%-91.3%) | 80% (95% CI, 77%-82%) |
| Specificity at threshold | 48.8% (95% CI, 46.6%-51.0%) | 62% (95% CI, 60%-64%) |

Different medical institutions may choose to modify the default thresholds for classifying a patient as low, medium or high risk based on model predictions. This will help to better guide oncology team and patient choices in the most appropriate manner for the local population. If the patient population is drastically different by race and income status, for example, it may make sense to customize the models for the local population by refitting the model to the local population data. Beta estimates would change, but predictors would remain the same, and the predictive accuracy of the modified models could be reassessed. The dataset will also be supplemented by any of the available variables tracked in the ANC study, but not included in the final model. If the population is substantially different, new predictors could help to increase the predictive accuracy of that model in that population.

As electronic data is stored in more standardized ways, “model and decision analysis customization” automation tools built into the risk assessment system can help to facilitate the most accurate possible predictions for specific populations and individuals within them. Tools to quickly calculate cost saving for an institution will help to increase demand for these products and speed implementation. Tracking the actual savings represents the best way to justify fees for use of the products to payers, e.g., insurers, Center for Medicare and Medicaid Services (CMS).

A comparison of the out-of-sample predictive accuracy assessments to the internal train-test set assessments (Table 1) can be made to assess the clinical generalizability of the chemotherapy solutions models produced. For a useful chemotherapy-related myelosuppression model, a c-statistic above 0.85 is targeted and at least one threshold where there is greater than 85% sensitivity and 50% specificity

The use of expert opinion chemotherapy standards (e.g., National Comprehensive Cancer Network, NCCN guidelines) combined with predictive models (e.g., myelosuppression adverse outcomes) to derive individual patient probabilities can deliver more accurate decision support than that which uses population-level incidence data. Further, incorporation into the risk assessment system could allow for rapid customization and delivery of the decision analysis model for local populations served by the institutions which implement these solutions. Having both a decision analysis and a cost-effectiveness framework in place will facilitate quality improvement tracking and pay for performance compensation to physicians and health systems, in line with the current efforts of CMS and insurers. Eliciting individual patient preferences and visualizing risks for both physicians and patients in enhancements of the chemotherapy solutions tool will also help to better empower patients to work with their physician on constructing a treatment plan that suits them best.

The chemotherapy solutions tool will be enhanced to automatically track the following data: (1) general usage statistics including use frequency and screen times; (2) real outcomes and their timing; (3) predicted outcomes; (4) therapy recommended by decision analysis; (5) oncology-practitioner selected therapy; (6) mismatch between decision analysis recommendations and physician choices. These features, and the ability for practitioners to participate in such studies via the risk assessment system's secure website will allow for larger scale tests of the chemotherapy solutions tool.

The system and method of the embodiments of the invention have been described as computer-implemented processes. It is important to note, however, that those skilled in the art will appreciate that the mechanisms of the embodiments described are capable of being distributed as a program product in a variety of forms, regardless of the particular type of physical signal bearing media utilized to carry out the distribution. Examples of signal bearing media include, without limitation, recordable-type media such as diskettes or CD ROMs.

The corresponding structures, materials, acts, and equivalents of all means plus function elements in any claims below are intended to include any structure, material, or acts for performing the function in combination with other claim elements as specifically claimed. Those skilled in the art will appreciate that many modifications to the exemplary embodiments are possible without departing from the scope of the present invention.

In addition, it is possible to use some of the features of the embodiments described without the corresponding use of other features. Accordingly, the foregoing description of the exemplary embodiments is provided for the purpose of illustrating the principles of the invention, and not in limitation thereof, since the scope of the invention is defined solely by the appended claims.

1. A computer-implemented method for determining an individual therapeutic treatment plan for a cancer patient, the method comprising the steps of:
a. entering medical information related to the cancer patient into a computerized risk assessment application;
b. receiving a default treatment plan for the cancer patient from the computerized risk assessment application, the plan including a risk score for the patient;
c. entering the patient's demographic information and cancer characteristics into the computerized risk assessment application;
d. modifying the default treatment plan by observing the modification of a risk score for the patient as the patient's demographic information and cancer characteristics are entered; and
e. confirming a treatment order for the patient based on a balancing of risk and treatment plan factors.
